(19) United States
(12) Patent Application Publication
(10) Pub. No.: US 2009/0227719 A1
(43) Pub. Date: Sep. 10, 2009

(54) Curable High Dielectric Constant Ink Composition and High Dielectric Film

(75) Inventors: Chin-Hsien Hung, Taichung County (TW); Shur-Fen Liu, Hsinchu County (TW); Meng-Huei Chen, Kaohsiung County (TW); Bih-Yih Chen, Hsinchu County (TW); Ming-Tsung Hung, Taipei County (TW); Man-Chun Yu, Hsinchu County (TW)

Correspondence Address: PAI PATENT & TRADEMARK LAW FIRM, 1001 FOURTH AVENUE, SUITE 3200, SEATTLE, WA, 98154, US

(73) Assignee: INDUSTRIAL TECHNOLOGY RESEARCH INSTITUTE, Hsinchu County (TW)

(21) Appl. No.: 12/044,928

(22) Filed: Mar. 7, 2008

(51) Int. Cl. C08K 3/10; C08L 61/00

(52) U.S. Cl. 524/413; 524/500; 524/542; 524/502

(57) ABSTRACT

The invention discloses a curable ink composition which comprises about 1-10 parts by weight of a curable epoxy resin system, about 1-30 parts by weight of ferroelectric ceramic powders, about 0.1-10 parts by weight of a polymeric dispersant, and about 50-96 parts by weight of a solvent. The ink composition is suitable for forming a high dielectric film by inkjet printing for built-in capacitors.

### BACKGROUND OF THE INVENTION

1. Field of the Invention

The invention relates to an ink composition and high dielectric film, and more particularly to a curable high dielectric constant ink composition and high dielectric film.

2. Description of the Related Art

Recently, with increasing demand for electronic products, the printed circuit board industry has flourished and developed. Since electronic products are being designed to be lighter, thinner, shorter, and smaller, and have signal transmission high-frequency capabilities, the amount of active and passive components on the printed circuit board is being increased.

In order to comply with passive component applications on printed circuit boards, passive components are being designed to be thinner, to reduce the volume occupied on a printed circuit board. Further, due to increased integration, the thinner passive components are being embedded onto the printed circuit board.

The process of embedding capacitors comprises directly forming capacitors into multi-layer printed circuit board, via etching, or screen printing processes. Furthermore, the embedded capacitor can be formed by resin coated copper through a build-up process, replacing forming of capacitors by surface mount technology. The aforementioned embedded capacitors can be directly fabricated during fabrication of a rigid printed circuit board (PCB).

Meanwhile, with high frequency, multi-functional capability, and portability prerequisites for electronic products employing printed circuit boards, dielectric layers are being designed to be thinner to increase capacitance.

Note that for embedding capacitors, printed circuit boards with an extra thin high dielectric constant substrate (less than several micrometers), must be fabricated to replace surface mounted decoupling capacitors. However, it is difficult to fabricate a dielectric layer with a capacitance of more than 1 nF/cm², by using current conventional PCB processes.

Also, since available PCB-compatible organic resins do not have enough dielectric constant, films made of the organic resins exhibit a capacitance of more than 1 nF/cm², unless the thickness thereof is greatly reduced. Therefore, to use the organic resins, the dielectric constant of a film made thereby must have a thickness of less than 5 μm.

In comparison with conventional methods for fabricating embedded capacitors such as etching or screen printing, inkjet printing employs a high dielectric constant ink that is directly printed on a substrate. The inkjet printing method is more suitable for fabricating embedded capacitors and is the most appropriate method when forming high capacitor integration under a low temperature (<200° C.), due to its simple fabricating process and minimal volume requirement. However, since viscosity of dielectric ink at operating temperature must be less than 100 cps, the ink has to be diluted with a large amount of solvent to achieve viscosity requirements, resulting in poor ink consistency and poor thermal and chemical resistances of the dielectric layer made by the ink.

Most related references disclose methods for fabricating capacitors and structures of each layer of the capacitors. There are few related references that disclose a prescription for a high dielectric constant ink composition. Further, the few related references simply disclose dielectric polymer and ceramic powder mixtures, rather than teaching or suggesting a film with extra-thin thickness and superior capacitance.

U.S. Pat. No. 5,162,977 discloses a capacitive structure, and a material of which is a mixture of epoxy resin and ceramic powders. However, the patent fails to disclose a detailed prescription and fails to consider compatibility for inkjet printing. Equally, U.S. Pat. Nos. 5,800,575 and 5,870,274 emphasize process and structure of the capacitors.

U.S. Pat. No. 5,739,193 discloses a dielectric polymer composition, comprising thermal plastic resin and powder, used to fabricate electronic products shaped by injection molding. U.S. Pat. No. 6,608,760 discloses forming a dielectric substrate with a composition having thermosetting resin and high dielectric constant powder. U.S. Pat. No. 6,905,757 discloses the process for fabricating embedded capacitors of printed circuit boards. Although the prescription and characteristics of the high dielectric constant composition are disclosed, the patent does not teach or suggest a composition suitable for inkjet printing.

The compositions of the aforementioned patents exhibit high viscosities (of more than 100 cps) and have large particle sizes (of more than 500 nm), and are thus, not suitable for forming capacitors by inkjet printing. Hence, a high dielectric constant composition suitable for inkjet printing would not be obtained by the teachings or suggestions of the conventional organic/inorganic high dielectric constant compositions.

U.S. Pat. Pub. No. 20050137281A1, the only patent that discloses forming dielectric film through inkjet printing, teaches or suggest a composition, comprising cyano-functional styrenic polymers and nanoscale BaTiO₃ powders, which serves as a high dielectric constant ink. However, application of the composition is limited due to poor thermal and chemical resistances of an obtained dielectric layer.

Therefore, it is necessary to develop a high dielectric constant ink with low viscosity and high stability for fabricating extra-thin embedded capacitors formed on capacitive substrate to increase the thermal and chemical resistances of the dielectric layer.

### BRIEF SUMMARY OF THE INVENTION

The object of the invention is to provide a curable high dielectric constant ink composition which can be used to fabricate an extra-thin capacitor layer by inkjet printing with superior thermal and chemical resistances.

In order to achieve the objective, the curable high dielectric constant ink composition of the invention comprises: about 1-10 parts by weight of a curable epoxy resin system; about 1-30 parts by weight of ferroelectric ceramic powders; 0.1-10 parts by weight of a polymeric dispersant; and about 50-96 parts by weight of a solvent, wherein the solvent has a boiling point not less than 100° C.

The invention further provides a high dielectric constant dielectric film fabricated by the above curable high dielectric constant ink composition via cross-link after curing.

A detailed description is given in the following embodiments with reference to the accompanying drawings.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention discloses a curable ink composition for forming a high dielectric film by inkjet printing, wherein the high dielectric film is extra-thin and has high thermal and chemical resistances suitable for serving as a capacitive dielectric layer of an embedded capacitive substrate. The curable ink composition comprises: (A) an epoxy resin system; (B) ferroelectric ceramic powders; (C) a polymeric dispersant; and (D) a solvent. The components will be clearly described in the following.

(A) Epoxy Resin System

The high dielectric constant ink composition comprises 1-10 parts by weight, more preferably 1-5 parts by weight, of an epoxy resin system (based on 100 parts by weight of the ink composition). The epoxy resin system comprises oxirane-ring containing monomer, oligomer, or polymer. Practical examples comprise:

(a) bisphenol A epoxy: diglycidyl ether of bisphenol A epoxy, tetrabromo bisphenol A diglycidyl ether epoxy;

(b) bisphenol F epoxy;

(c) bisphenol S epoxy;

(d) cyclo aliphatic epoxy resin: dicyclopentadiene epoxy resin;

(e) naphthalene epoxy resin;

(f) diphenylene epoxy resin;

(g) phenol novolac epoxy resin;

(h) o-cresol novolac epoxy resin;

(i) multi-functional groups epoxy resin:

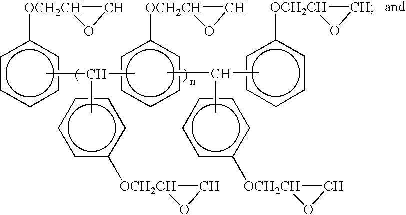

(j) aliphatic chain epoxy resin:

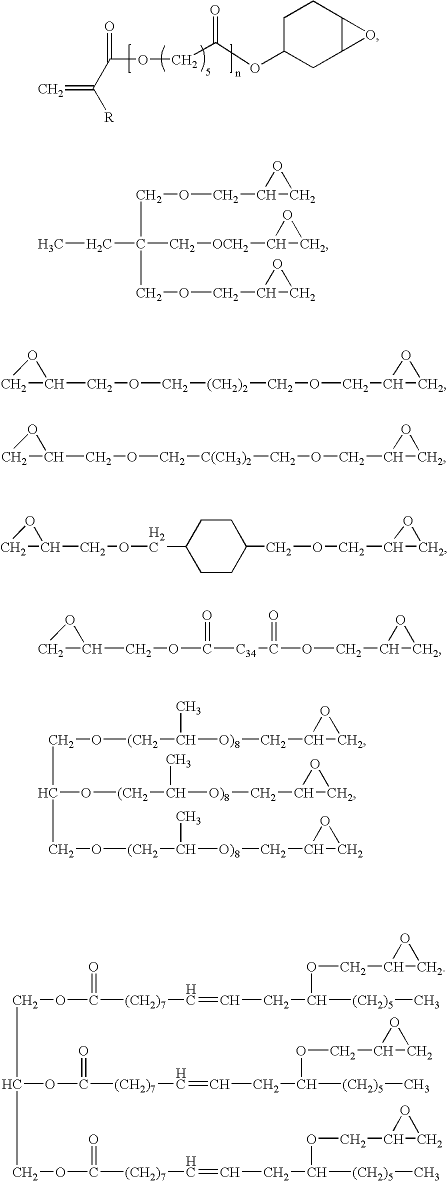

The aforementioned epoxy resin can be used alone or in combination, depending upon required characteristics or process. According to the invention, the epoxy resin can have a glass transition temperature of above 150° C., more preferably 180° C., to enhance thermal resistance. The epoxy resin system, except for epoxy resin, can optionally comprise one or more thermal plastic resins, such as polyvinyl butyra, acrylic resin, polyamide-imide, or combinations thereof, thereby increasing flexibility. Further, except for epoxy resin, the epoxy resin system can further comprise a curing agent and a catalyst. The curing agent has 5-40 parts by weight, based on 100 parts by weight of the epoxy resin. The preferable curing agent comprises:

(a) diamine: H₂N—R₁—NH₂,

wherein R₁ can be aryl group, aliphatic group, cyclo-aliphatic group, or silane-containing aliphatic group;

(b) anhydride:

hexahydrophthalic anhydride (HHPA), tetrahydrophthalic anhydride (THPA), methyl tetrahydrophthalic anhydride (MTHPA), or methyl hexahydrophthalic anhydride (MHHPA); and

(c) phenol resin:

phenol based resins, naphthol based resins, terpene phenol resins, dicyclopentadiene resins, 4,4′,4″-ethylidene trisphenol, tetraphenylol ethane, tetraxylenol ethane, or tetracresolol ethane.

The catalyst has 0.1˜5 parts by weight, based on 100 parts by weight of the epoxy resin. The preferable catalyst comprises:

(a) cationic catalyst: boron trifluoride complex (such as RNH₂.BF₃, R₂NH.BF₃, R₃N.BF₃ (R is an alkyl group));

(b) anionic catalyst: tertiary amines, metal hydroxide, single-ring oxide coordination anionic catalyst (such as R₃N(R is an alkyl group), tetramethylguanidine (TMG), NCH₂C—C(NH)—N(CH3)₂); and

(c) imidazole: 1-methylimidazole, 1,2-dimethylimidazole, 2-heptadecylimidazole, 2-ethyl-4-methylimidazole.

(B) Ferroelectric Ceramic Powders

The high dielectric constant ink composition of the invention comprises 1-30 parts by weight, more preferably 5-20 parts by weight, ferroelectric ceramic powder (based on 100 parts by weight of the ink composition). The ferroelectric ceramic powder can be BaTiO₃, Ba(Sr)TiO₃, or metal-implanted BaTiO₃, or Ba(Sr)TiO₃ (the implanted metal ions can be Ca, Zr, Mg). The ferroelectric (high dielectric constant) ceramic powder of the ink composition of the invention has a particle size of between 10-400 nm, more preferably less than 250 nm in order to be used in inkjet printing and enhance density of a dielectric layer formed by inkjet printing.

The sprinkle-nozzle gets blocked when the ceramic powder has a particle size of more than 500 nm. Further, two or more kinds of ceramic powders can be used to increase packing density, and enhance capacitance.

(C) Dispersant

The high dielectric constant ink composition of the invention comprises 0.1-10 parts by weight, more preferably 1-5 parts by weight, dispersant (based on 100 parts by weight of the ink composition).

The dispersant is provided to permanently stabilize the ferroelectric ceramic powders dispersed among the ink composition comprising curable epoxy resin, and to avoid particle aggregation of the ceramic powders which would increase viscosity during storage in cartridge. Therefore, the dispersant helps maintain the best performance of the ink drop size, inkjet speed, and ink drop direction variation during inkjet printing.

In order to achieve the above objectives, a polymeric dispersant is used to disperse the ferroelectric ceramic powders due to superior adhesion with inorganic powders and high compatibility with organic resins (reactivity with organic resin), thereby substantially increasing the thermal resistance and reliability of the dielectric film.

The polymeric dispersant comprises polyester, polyamide, polyaminoester, polyphosphate, copolymers thereof, or combinations thereof. Particularly, the polymeric dispersant can comprise lipophilic polymeric dispersant, amphiphilic polymeric dispersant, or combinations thereof, preferably lipophilic polymeric dispersant. The polymeric dispersant of the invention comprises (but is not limited to) BYK-9010 (sold and fabricated by BYK chemie), KD series (sold and fabricated by Uniqema), and AD01 (sold and fabricated by Air products).

(D) Solvent

The high dielectric constant ink composition of the invention comprises 50˜96 parts by weight, more preferably 55-85 parts by weight, solvent (based on 100 parts by weight of the ink composition). The solvent of the invention has a boiling point not less than 100° C., thereby increasing the vapor pressure of the ink to avoid poor printing performance. A suitable solvent of the invention comprises acid-ester, alcohol, amide, or combinations thereof, such as, but are not limited to, ethyl lactate, butyl acetate, diethylene glycol monobutyl ether acetate, toluene, xylene, butanol, ethylene golycol, propylene glycol, methoxy propylene glycol, ethoxy propylene glycol, dimethylacetamide, or combinations thereof.

It should be noted that the composition can comprise only one solvent or various solvents. Therefore, except for the solvent having a boiling point more than 100° C., the composition can simultaneously comprise co-solvents having boiling points less than 100° C., such as ethanol, propanol, or ethyl acetate.

(E) Additives

Excluding the aforementioned components, the high dielectric constant ink composition of the invention can comprise conventional additives used in ink or dielectric film, such as adhesion promoter, silane coupling agent, or surfactant (based on the premise that performance and dielectric constant are not hindered). The silane coupling agent can be epoxysilane, or aminosilane, and the adhesion promoter can be the compound represented by:

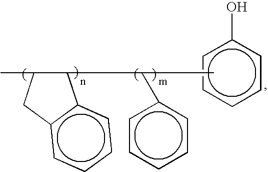

wherein n, and m are numbers of repeat units.

The high dielectric constant ink composition of the invention has a viscosity of between 1-100 cps, and the viscosity can be modified according to the operating temperature of a printer and sprinkle-nozzle size. The high dielectric constant ink composition has a surface tension of 20-60 dyne/cm, and the surface tension can be modified according to the hydrophile and hydrophobicity of the substrate, enhancing the adhesion of the ink composition.

The high dielectric constant ink composition of the invention has superior storage and inkjet characteristics, and the obtained dielectric film (after curing the composition) exhibits high thermal and chemical resistances. Further, the dielectric film prepared from the high dielectric constant ink composition has high dielectric constant, suitable for fabricating extra-thin embedded capacitors (has a thickness of less than 5 μm). In an embodiment of the invention, the obtained dielectric film can have a dielectric constant (1 MHz) of more than 10.

It should be noted that the high dielectric constant ink composition of the invention can be used to form a dielectric film by, with the exception of inkjet printing, gravure coating, spin coating, blade coating, letterpress, and flexography. Further, the obtained extra-thin dielectric film can be used not only for embedded capacitors but also other dielectric devices, such as transistors, diodes, and electric resistors.

### EXAMPLE 1

### Ferroelectric Ceramic Powder Dispersion

100 g BT-1 (BaTiO3, sold and fabricated by Inframat Advanced Materials) with an average particle size of 100 nm, 20 g polymeric dispersant A (acid group copolymer) (with a trade no. BYK-9010, sold and fabricated by BYK chemie), 760 g abrasive materials (zirconia bead), and 150 g ethyl lactate solvent were mixed, and the mixture was wetted and dispersed by sand mill for 2 hrs. After milling, the ferroelectric ceramic powder dispersion was obtained by removing the zirconia bead.

<Resin Adhesive System>

10.50 g bisphenol A epoxy resin (bisphenol-A diglycidyl ether) (with a trade no. 188EL, sold and fabricated by Chang Chun Plastics Co., Ltd.), 7.70 g tetrabromo disphenol-A diglcidyl ether (with a trade no. BEB-350, sold and fabricated by Chang Chun Plastics Co., Ltd.), 2.70 g cyclo aliphatic epoxy) (with a trade no. HP-7200, sold and fabricated by DIC), 3.70 g multifunctional epoxy system (with a trade no. EPPON502H, sold and fabricated by Nippon Kayaku Co., Ltd.) and 460 g ethyl lactate solvent were added into a reactor and heated at 90° C. for 30 mins. After cooling, a resin adhesive-1 was obtained. The result was mixed with 5.60 g hexahydrophthalic anhydride (as a curing agent, sold and fabricated by ACROS) and 0.08 g 2-ethyl-4-methylimidazole (as a catalyst, sold and fabricated by ACROS) by a high-speed mixer at 2000 rpm for 10 mins, and the resin adhesive system was obtained.

### <High Dielectric Constant Ink>

2.5 g of the above ferroelectric ceramic powder dispersion was added into 6.4 g of the above resin adhesive system. After stirring for 30 mins, a curable dielectric ink composition was obtained. Next, the ink composition was filled into the cartridge of a Dimatix printer (DMCLCP-11610). The inkjet printability was evaluated by a built-in drop jetting observation system of the Dimatix printer (DMP2800). The ink composition was printed on a copper foil substrate and baked at 180° C. for 2.5 hrs, forming a dielectric film by cross-link.

### EXAMPLE 2

Example 2 was performed as Example 1 except for substitution of BT-2 (BaTiO3, sold and fabricated by Prosperity Dielectrics Co) with an average particle size of 300 nm for BT-1 with an average particle size of 100 nm. The amounts and components are shown in Table 1.

### EXAMPLE 3

Example 3 was performed as Example 1 except for substitution of lipophilic polymeric dispersant C (with a trade no. KD-1, sold and fabricated by Uniqema Hypermer dispersant) for polymeric dispersant A. The amounts and components are shown in Table 1.

### EXAMPLE 4

Example 4 was performed as Example 1 except for substitution of BT-1 and BT-2 for BT-1. The amounts and components are shown in Table 1.

### EXAMPLE 5

Example 5 was performed as Example 1 except for addition of Polyvinyl butyral into resin adhesive system. The above resin adhesive system was prepared as follows.

9.2 g bisphenol A epoxy resin (bisphenol-A diglycidyl ether) (with a trade no. 188EL, sold and fabricated by Chang Chun Plastics Co., Ltd.), 6.50 g tetrabromo disphenol-A diglcidyl ether (with a trade no. BEB-350, sold and fabricated by Chang Chun Plastics Co., Ltd.), 1.60 g cyclo aliphatic epoxy (with a trade no. HP-7200, sold and fabricated by DIC), 2.40 g multifunctional epoxy system (with a trade no. EPPON₅₀₂H, sold and fabricated by Nippon Kayaku Co., Ltd.), 4.91 g Polyvinyl butyral (PVB, sold and fabricated by Chang Chun Plastics Co., Ltd.) and 460 g ethyl lactate solvent were added into a reactor and heated at 90° C. for 30 mins. After cooling, a resin adhesive-2 was obtained. The result was mixed with 5.60 g hexahydrophthalic anhydride (as a curing agent, sold and fabricated by ACROS) and 0.08 g 2-Ethyl-4-methylimidazole (as a catalyst, sold and fabricated by ACROS) by a high-speed mixer at 2000 rpm for 10 mins, and the resin adhesive system was obtained.

### EXAMPLE 6

The components were the same as Example 1. 1.0 g of ferroelectric ceramic powder dispersion and 3.8 g of resin adhesive system were dissolved into 15 g ethyl lactate solvent. After stirring for 30 mins, a curable dielectric ink composition was obtained.

### EXAMPLE 7

Example 7 was performed as Example 1 except for the substitution of 40 g ethyl lactate, for the 460 g ethyl lactate solvent, in resin adhesive system. 2.8 g of ferroelectric ceramic powder dispersion was added into 1.02 g of the above resin adhesive system. After stirring for 30 mins, a curable dielectric ink composition was obtained.

### COMPARATIVE EXAMPLE 1

Comparative Example 1 was performed as Example 1 except for substitution of a hydrophilic polymeric dispersant B (with a trade no. BYK-112, sold and fabricated by BYK chemie) for polymeric dispersant A. The amounts and components are shown in Table 1.

### COMPARATIVE EXAMPLE 2

Comparative Example 2 was performed as Example 1 except for substitution of methyl ethyl ketone for ethyl lactate. The amounts and components are shown in Table 1.

### COMPARATIVE EXAMPLE 3

Comparative Example 3 was performed as Example 1 except for substitution of BT-2 for BT-1 and substitution of isopropyl alcohol for ethyl lactate. The amounts and components are shown in Table 1.

### COMPARATIVE EXAMPLE 4

Comparative Example 4 was performed as Example 1 except for absence of epoxy resin adhesive. The amounts and components are shown in Table 1.

TABLE 1

| | | | | | | | | | | |
|---|---|---|---|---|---|---|---|---|---|---|
| Co. | Co. | Co. | Co. | | | | | | | |
| Exp 1 | Exp 2 | Exp 3 | Exp 4 | Exp 1 | Exp 2 | Exp 3 | Exp 4 | Exp 5 | Exp 6 | Exp 7 |

ferroelectric ceramic powder dispersion

| | | | | | | | | | | | |
|---|---|---|---|---|---|---|---|---|---|---|---|
| BT-1 | 100.0 | 95.7 | 0 | 80.0 | 100.0 | 0 | 100.0 | 20.0 | 100.0 | 100.0 | 120.0 |
| BT-2 | 0 | 0 | 90.4 | 0 | 0 | 100 | 0 | 80.0 | 0 | 0 | 0 |
| dispersant A | 0 | 19.5 | 16.7 | 0 | 20.0 | 20.0 | 0 | 20.0 | 20.0 | 20.0 | 40.0 |
| dispersant B | 20.0 | 0 | 0 | 0 | 0 | 0 | 0 | 0 | 0 | 0 | 0 |
| dispersant C | 0 | 0 | 0 | 10.1 | 0 | 0 | 20.0 | 0 | 0 | 0 | 0 |
| solvent | 150.0 | 0 | 0 | 150.0 | 150.0 | 150.0 | 150.0 | 150.0 | 150.0 | 150.0 | 150.0 |
| (ethyl lactate) | | | | | | | | | | | |
| solvent | 0 | 150.7 | 0 | 0 | 0 | 0 | 0 | 0 | 0 | 0 | 0 |
| (methyl ethyl | | | | | | | | | | | |
| ketone) | | | | | | | | | | | |
| solvent | 0 | 0 | 150.6 | 0 | 0 | 0 | 0 | 0 | 0 | 0 | 0 |
| (isopropyl | | | | | | | | | | | |
| alcohol) | | | | | | | | | | | |

resin adhesive system

| | | | | | | | | | | | |
|---|---|---|---|---|---|---|---|---|---|---|---|
| epoxy resin | 486.4 | 0 | 0 | 0 | 484.6 | 486.5 | 486.0 | 485.6 | 0 | 484.6 | 64.6 |
| adhesive-1 | | | | | | | | | | | |
| (solvent: ethyl | | | | | | | | | | | |
| lactate) | | | | | | | | | | | |
| epoxy resin | 0 | 0 | 0 | 0 | 0 | 0 | 0 | 0 | 484.7 | 0 | 0 |
| adhesive-2 | | | | | | | | | | | |
| (solvent: ethyl | | | | | | | | | | | |
| lactate) | | | | | | | | | | | |
| epoxy resin | 0 | 486.5 | 0 | 0 | 0 | 0 | 0 | 0 | 0 | 0 | 0 |
| adhesive-3 | | | | | | | | | | | |
| (solvent: methyl | | | | | | | | | | | |
| ethyl ketone) | | | | | | | | | | | |
| epoxy resin | 0 | 0 | 487.0 | 0 | 0 | 0 | 0 | 0 | 0 | 0 | 0 |
| adhesive-4 | | | | | | | | | | | |
| (solvent: isopropyl | | | | | | | | | | | |
| alcohol) | | | | | | | | | | | |
| curing agent | 5.60 | 5.62 | 5.53 | 0 | 5.60 | 5.58 | 5.59 | 5.61 | 5.60 | 5.60 | 5.61 |
| catalyst | 0.08 | 0.08 | 0.07 | 0 | 0.08 | 0.08 | 0.08 | 0.08 | 0.08 | 0.08 | 0.08 |

TABLE 2

| | Co. | Co. | Co. | Co. | | | | | | | |
|---|---|---|---|---|---|---|---|---|---|---|---|
| characteristic | Exp 1 | Exp 2 | Exp 3 | Exp 4 | Exp 1 | Exp 2 | Exp 3 | Exp 4 | Exp 5 | Exp 6 | Exp 7 |
| Inkjet printability | bad | bad | bad | good | good | good | good | good | good | good | good |
| | (block) | (block) | (block) | | | | | | | | |
| Viscosity of ink | 12.0 | 7.8 | 6.9 | 9.2 | 9.9 | 9.8 | 8.8 | 8.9 | 10.6 | 3.2 | 12.8 |
| (cps) | | | | | | | | | | | |
| Surface tension of | 30.7 | 24.2 | 21.4 | 30.5 | 30.8 | 31.3 | 30.6 | 30.8 | 30.2 | 30.5 | 30.9 |
| ink(dyne/cm) | | | | | | | | | | | |
| Dielectric | 13.33 | 12.26 | 8.70 | 79.2 | 18.32 | 25.34 | 20.15 | 19.20 | 18.61 | 11.2 | 13.3 |
| constant (1 MHz) | | | | | | | | | | | |
| Glass transition | 174 | 175 | 178 | 105 | 183 | 184 | 187 | 182 | 180 | 181 | 182 |
| temperature Tg | | | | | | | | | | | |
| (° C.) | | | | | | | | | | | |
| Thickness of | 1.8 | 2.3 | 2.8 | 2.7 | 3.5 | 4.2 | 3.5 | 3.8 | 3.3 | 1.2 | 4.5 |
| dielectric film | | | | | | | | | | | |
| (μm) | | | | | | | | | | | |
| Chemical | pass | pass | pass | fail | pass | pass | pass | pass | pass | pass | pass |
| resistance* | | | | | | | | | | | |

*Chemical resistance was measured by ASTM D5402-93 (Re-approved 1999) (rubbed with MEK and repeated 10 times)

As the measurements in Table 2 showed, in Comparative Example 1, the inkjet printability was bad, resulting from ink block, due to the use of the hydrophilic dispersant. Further, according to Comparative Examples 2 and 3, with the solvent replaced by methyl ethyl ketone and isopropyl alcohol, the inkjet printability was bad resulting from the low vapor pressure of ink. Moreover, according to Comparative Example 4, the dielectric film fabricated by the ink composition had inferior thermal and chemical resistances, due to the absence of the curable epoxy resin adhesive.

Comparatively, in Example 1, the inkjet printing performance was good and the obtained dielectric film exhibited a dielectric constant of 18.32, since ethyl lactate had a higher boiling point. Further, in Example 2, the inkjet printability was good and the obtained dielectric film exhibited superior electric characteristics resulting from the solvent selection, dispersant addition and milling dispersion, even though the BaTiO₃, with an average particle size of 300 nm, was used. The glass transition temperature of the dielectric film can achieve 184° C.

Moreover, the ink composition can comprise two kinds of ferroelectric ceramic powders to increase the packing density of the ceramic powders and enhance the thickness uniformity, resulting in high capacitance and dielectric constant of 19.20.

Accordingly, the curable ink composition of the invention can be used to fabricate an extra-thin dielectric film with high capacitance, thermal resistance, and chemical resistance, after curing. Further, the curable ink composition exhibited high storage stability and is suitable for an inkjet printing process.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A curable ink composition, comprising:
about 1-10 parts by weight of a curable epoxy resin system;
about 1-30 parts by weight of ferroelectric ceramic powders; 0.1-10 parts by weight of a polymeric dispersant; and
about 50-96 parts by weight of a solvent, wherein the solvent has a boiling point not less than 100° C.

2. The curable ink composition as claimed in claim 1, wherein the curable epoxy resin system comprises polyvinyl butyra, acrylic resin, polyamide-imide, or combinations thereof.

3. The curable ink composition as claimed in claim 1, wherein the ferroelectric ceramic powders comprise BaTiO₃, Ba(Sr)TiO₃, metal-implanted compounds thereof, or combinations thereof.

4. The curable ink composition as claimed in claim 1, wherein the particle size of the ferroelectric ceramic powders is of between 10-400 nm.

5. The curable ink composition as claimed in claim 1, wherein the polymeric dispersant comprises polyester, polyamide, polyaminoester, polyphosphate, copolymers thereof, or combinations thereof.

6. The curable ink composition as claimed in claim 1, wherein the polymeric dispersant comprises lipophilic polymeric dispersant, amphiphilic polymeric dispersant, or combinations thereof.

7. The curable ink composition as claimed in claim 1, wherein the solvent comprises acid-ester, alcohol, amide, or combinations thereof.

8. The curable ink composition as claimed in claim 1, wherein the solvent comprises ethyl lactate, butyl acetate, diethylene glycol monobutyl ether acetate, toluene, xylene, butanol, ethylene golycol, propylene glycol, methoxy propylene glycol, ethoxy propylene glycol, dimethylacetamide, or combinations thereof.

9. The curable ink composition as claimed in claim 1, wherein the curable epoxy resin system comprises bisphenol A epoxy resin, bisphenol F epoxy resin, bisphenol S epoxy resin, cyclo aliphatic epoxy resin, naphthalene epoxy resin, diphenylene epoxy resin, phenol novolac epoxy resin, o-cresol novolac epoxy resin, multi-functional groups epoxy resin, or combinations thereof.

10. The curable ink composition as claimed in claim 1, wherein the curable epoxy resin system further comprises a curing agent.

11. The curable ink composition as claimed in claim 1, wherein the curable epoxy resin system further comprises a catalyst.

12. The curable ink composition as claimed in claim 1, further comprising a co-solvent having a boiling point less than 100° C.

13. The curable ink composition as claimed in claim 1, wherein the composition has a surface tension of 20-60 dyne/cm.

14. The curable ink composition as claimed in claim 1, wherein the composition has a viscosity of 1-100 cps.

15. A high dielectric constant film, comprising a cross-linking product of the curable ink composition as claimed in claim 1.

16. The high dielectric constant film as claimed in claim 15, wherein the high dielectric constant film serves as the capacitive dielectric of an embedded capacitive substrate.

17. The high dielectric constant film as claimed in claim 15, wherein the high dielectric constant film has a dielectric constant (1 MHz) more than 10.
